(19) United States
(12) Patent Application Publication
(10) Pub. No.: US 2011/0238209 A1
(43) Pub. Date: Sep. 29, 2011

(54) Vending Systems and Methods

(75) Inventors: Jurgen Roekens, Kampenhout (BE); Willy Van Esch, Grez-Doiceau (BE)

(73) Assignee: THE COCA-COLA COMPANY, Atlanta, GA (US)

(21) Appl. No.: 12/731,168

(22) Filed: Mar. 25, 2010

(51) Int. Cl. G06F 17/00; G06K 9/00

(52) U.S. Cl. 700/237; 235/381

(57) ABSTRACT

A vending system for dispensing a number of products. The vending system may include an enclosure with an access point, a weighing system, a user interface, and an access system. The user interface may include a proximity card coupling device to read and write to a proximity card. The access system allows the access point of the enclosure to be opened in response to the user interface.

### TECHNICAL FIELD

The present application relates generally to vending systems and more particularly relates to a weight based vending system with tamper-proof access and an improved user interface.

### BACKGROUND OF THE INVENTION

Traditional vending machines generally are positioned in locations of moderate to heavy consumer traffic to ensure sufficient use and profitability. Locations with less consumer traffic, such as certain offices, hospitals, schools, retail establishments, and the like, may not be well suited for the usual size and expense related to the use of a traditional vending machine. Specifically, the components of the vending machine, such as the vending mechanism, the refrigeration equipment, the payment equipment, the product stocks, and the like, may be relatively expensive to provide and operate. Moreover, the size of the traditional vending machine may result in a slow rotation of product therethrough if the sales volume is relatively low. The noise and aesthetics associated with many vending machines also may not be appropriate for office use or other locations.

Coolers, particularly glass door coolers, may be somewhat less expensive to provide and operate given the lack of at least the vending mechanism. Glass door coolers also generally offer the advantage of allowing the consumer to see the products available within the cooler. Such visibility may provide the opportunity to promote the products therein and also may promote impulse purchases. The lack of the vending mechanism, however, generally means that the removal of the products from the cooler cannot always be controlled. Low cost payment solutions, such as an honesty box placed next to the cooler, may be provided but also may be subject to abuse given the lack of controlled access.

There is thus a desire for improved vending systems and methods. Such improved vending systems and methods may offer the positive features of a glass door cooler but with appropriate vending and payment controls. Such improved vending systems and methods should be less expensive to provide and operate as compared to a traditional vending machine and the like.

### SUMMARY OF THE INVENTION

The present application thus provides a vending system for dispensing a number of products. The vending system may include an enclosure with an access point, a weighing system, a user interface, and an access system. The user interface may include a proximity card coupling device to read and write to a proximity card. The access system allows the access point of the enclosure to be opened in response to the user interface.

The enclosure may include a glass door cooler. Each of the number of products may include a substantially identical weight. The user interface may be a user interface module. The proximity card may include a key and the user interface may include a key hole for mating therewith. The user interface may include a key retaining solenoid, a display, and a controller. The access system may include a bar positioned by the access point. The bar may be operated by a solenoid. The weighing system may be a weighing module. The weighing system may include a number of weight transducers and a proximity sensor positioned about the access point.

The present application further provides a method of vending a number of products from an enclosure. The method may include the steps of reading a proximity card in a user interface, determining if the proximity card has a sufficient amount of credit thereon, allowing an access point of the enclosure to be opened if the proximity card has the sufficient amount of credit therein, weighing the enclosure, determining the number of products removed from the enclosure based upon the weight of the enclosure, determining the value of the number of products removed, and writing a revised credit balance onto the proximity card at the user interface.

The method further may include the steps of accepting the proximity card in the user interface, locking the proximity card within the user interface, displaying a message on the user interface if the proximity card does not have a sufficient amount of credit thereon, determining when the access point of the enclosure is shut, and locking the access point of the enclosure once the access point is shut.

The present application further may provide for a vending system for dispensing a number of products. The vending system may include a cooler with a glass door, a weighing module positioned under the cooler, a user interface module positioned about the cooler and in communication with the weighing module, and an access system positioned about the door of the cooler. The user interface may include a proximity card coupling device to read and write to a proximity card. The access system allows the door of the cooler to be opened in response to the user interface determining that the proximity card has a sufficient amount of credit thereon.

These and other features and improvements of the present application will become apparent to one of ordinary skill in the art upon review of the following detailed description when taken in conjunction with the several drawings and the appended claims.

### BRIEF DESCRIPTION OF THE DRAWINGS

FIG. 1 is a perspective view of a glass door cooler.

FIG. 2 is a front perspective view of a vending system as may be described herein.

FIG. 3 is a rear perspective view of the vending system of FIG. 2.

FIG. 4 is an exploded view of the vending system of FIG. 2.

FIG. 5 is an exploded view of a user interface of the vending system of FIG. 2.

FIG. 6 is an exploded view of the weighing system and the access system of the vending system of FIG. 2.

FIG. 7 is a flow chart showing the steps of a transaction with the vending system.

### DETAILED DESCRIPTION

The present application concerns the vending of any number of products 10. Although the products 10 are shown, by way of example only, in the form of bottles, it is understood that the products 10 may include any type or size of item or package, including, but not limited to, bottles, cans, pouches, boxes, wrapped items, produce, and/or any type of rigid or flexible packaging. The products 10 may include beverages, food items, non-food items, consumer products, and/or any type of product 10 that may be vended. The scope of this application is in no way limited by the nature of the products 10 intended to be vended herein or otherwise. Similarly, although one use herein is for a chilled product 10, it will be understood that the products 10 herein may be offered at ambient temperatures, frozen temperatures, elevated temperatures, or at any temperature.

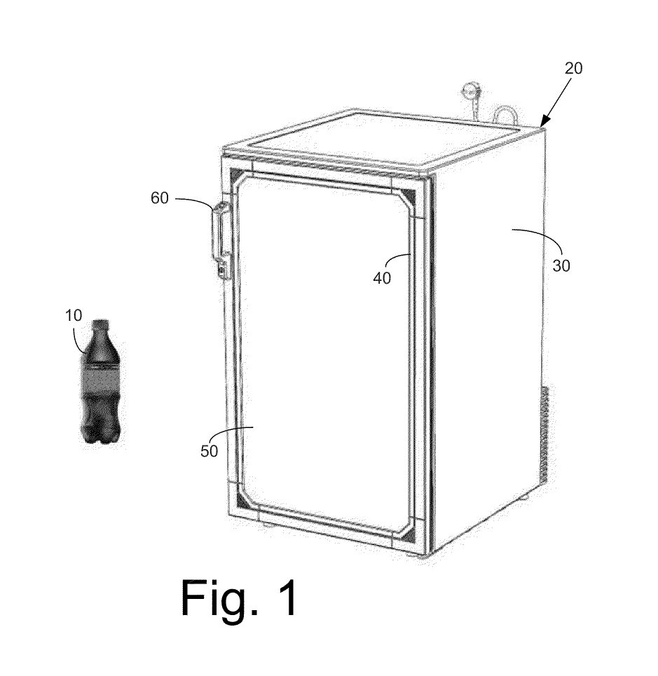

Referring now to the drawings, in which like numerals refer to like elements throughout the several views, FIG. 1 shows a cooler 20. As is known, the cooler 20 may include an outer frame 30 enclosed by a door 40. The frame 30 and the door 40 may be largely of conventional design and may be insulated as desired. The door 40 may include a transparent panel 50 therein. The transparent panel 50 may be made out of glass and the like. The door 40 may swing open and may include a handle 60. The cooler 20 may have any desired size or shape. The cooler 20 may include a cooling and/or heating device 70. The cooling and/or heating device 70 may be of conventional design. The cooler 20 may run on electrical power.

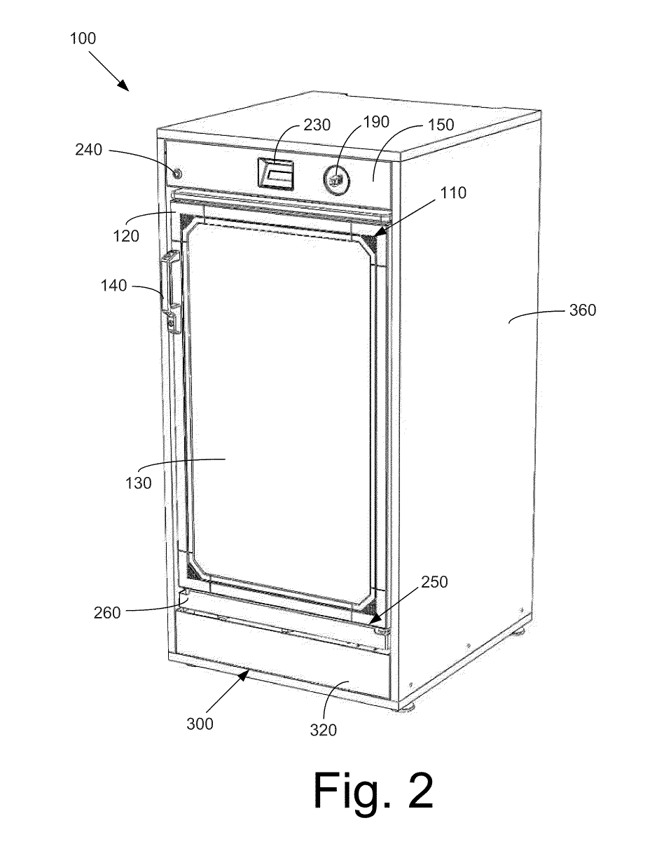

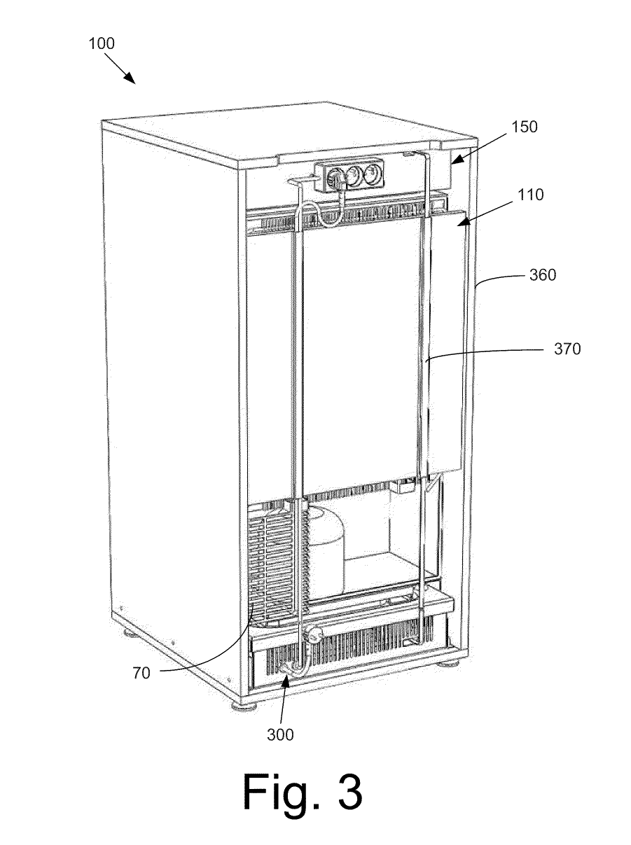

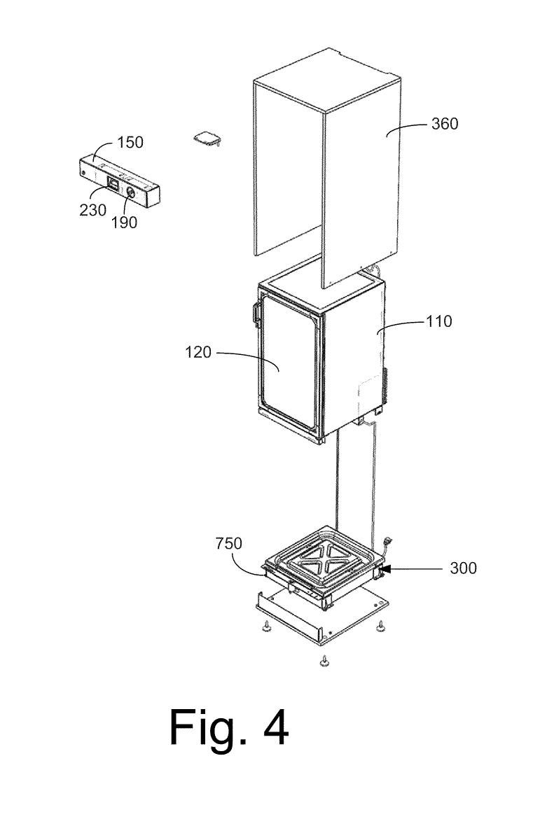

FIGS. 2-4 show a vending system 100 as may be described herein. The vending system 100 may include a cooler 110. The cooler 110 may be similar to the cooler 20 described above and may include a door 120 with a transparent panel 130 or other type of access point. The door 120 also may include a handle 140. The cooler 110 may have any desired size or shape and may be any type enclosure. No modification of the components of the cooler 110 may be required for use with the vending system 100. As such, the cooler 110 may be an existing unit or original equipment.

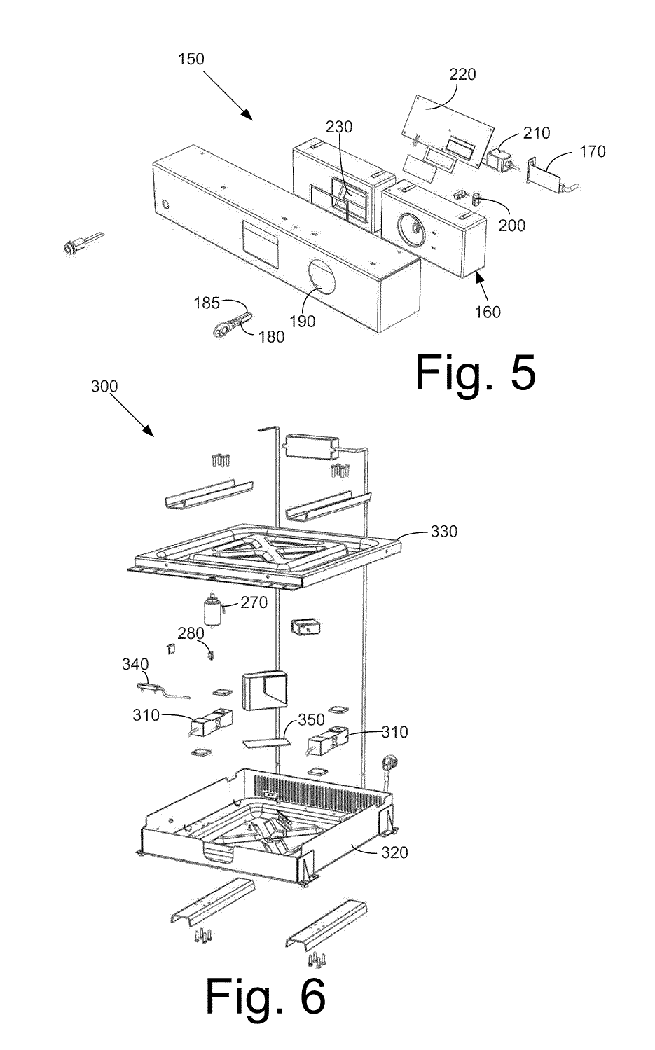

The vending system 100 also may include a user interface 150. The user interface 150 may be a separate module or integral with the system 100 as a whole. As is shown in FIG. 5, the user interface 150 may include an electronic payment system 160. In this example, the electronic payment system 160 may include a proximity card coupling device such as Radio Frequency Identification (“RFID”) reader 170 that may communicate with a proximity card such as a RFID card 180. The RFID card 180 may be a proximity card such as a MIFARE card offered by NXP Semiconductors of Eindhoven, Netherlands. Similar cards may be offered by Paytec Spa of Como, Italy. Similar devices may be used herein. The RFID card 180 may be positioned on a key 185 or other type of mounting.

In this example, the key 185 may be inserted within a key hole 190 of the user interface 150. One or more key sensing micro-switches 200 or similar devices may sense the presence of the RFID key 180 so as to activate the RFID reader 170. The RFID reader 170 then may read and/or write identification data, purchase data, or other types of information onto the RFID card 180 in a conventional manner. A key retaining solenoid 210 may be positioned about the RFID reader 170 so as to lock the key 185 within the key hole 190 during use or if misuse, abuse, or other types of undesirable conditions may be detected. (Non-contact systems also may be used such that the RFID card 180 simply may need to be in proximity to the RFID reader 170.) The RFID card 180 also may communicate with a reading and writing station (not shown) so as to add credit and/or other types of information to the RFID card 180. The reading and writing station also may be part of the user interface 150 or positioned elsewhere.

The user interface 150 may include a controller 220 therein. The controller 220 may be any type of conventional microprocessor and the like. The controller 220 may be in communication with the electronic payment system 160 and with the other components of the vending system 100 as a whole. A serial connector port and/or USB port or other types of communication means also may be used herein. Preferably, the electronic payment system 160 and the vending system 100 as a whole are not networked, but could be so if desired.

Although the electronic payment system 160 has been described herein in the context of the RFID reader 170, any other type of electronic payment device may be used such as other types of smart cards, cell phones, PDA's, and the like. Conventional cash and/or credit payment systems also may be used herein but may add to the expense and complexity of the vending system 100 as a whole.

The user interface 150 also may include a display panel 230. The display panel 230 may be a LED display, a video display, or any type of display device that may communicate with a user. The display panel 230 may have any desired size, shape, or position. Sound also may be used. The user interface 150 also may include a reset switch 240. The user interface 150 likewise may include other components and configurations herein.

The vending system 100 also may include an access system 250. As is shown in FIG. 6, the access system 250 may include a bar 260 or other structure positioned about the door 120 or other type of access point of the cooler 110. The bar 260 may be maneuverable via a solenoid 270. The solenoid 270 may maneuver the bar 260 so as to prevent or allow the door 120 of the cooler 110 to be opened. The bar 260 may be maneuvered in front of the door 120 or may otherwise engage the door 120 along the side or otherwise so as to prevent opening. The bar 260 may be in the form of a rail or a similar structure that prevents the door 120 from opening. Likewise, other types of drive means may be used instead of the solenoid 270. The position of the bar 260 may be determined by a status detector switch 280 or otherwise. The access system 250 may be in communication with the user interface 150 as will be described in more detail below. The access system 250 likewise may include other components and configurations.

The vending system 100 also may include a weighing system 300. The weighing system 300 may be a separate module or integral with the system 100 as a whole. The weighing system 300 may be positioned underneath the cooler 110. As is shown in FIG. 6, the weighing system 300 may include a number of weight transducers 310. The weight transducers 310 may be of conventional design and may sense changes in the weight of the cooler 110. The weight transducers 310 may be mounted on a base 320 and in communication with a lid 330. Other types of weight or load sensing mechanisms and devices may be used herein. The weighing system 300 may include a proximity sensor 340 to determine when the door 120 of the cooler 110 is closed. A controller 350 also may be used herein or the controller 220 of the user interface module 150 also may control the weighing system 300. The weighing system 300 may be in communication with the user interface 150. The weighing system 300 likewise may include other components and configurations.

The components of the vending system 100 may be positioned within a cabinet 360 or other type of enclosure. The use of the cabinet 360 may reduce the possibility of someone pushing down or up on the cooler 120 so as to vary the results of the weighing system 300 or otherwise tampering with the components of the vending system 100 as a whole. The cooler 110, the user interface 150, the access system 250, the weighing system 300, and other components herein may plug in or share a common electrical system 370. The electrical system 370 in turn may be communication with a Conventional electrical outlet and the like.

Although the components of the access system 250 are shown as being integrated within the weighing system 300, the access system 250 and the weighing system 300 may be separate components. Moreover, numerous other configurations of elements may be used herein. For example, the user interface 150 may be positioned about the bottom of the cooler 110 if the vending system 100 is to be placed on, for example, a countertop. Further, one user interface 150 may be used with multiple coolers 110 as well as multiple weighing systems 300 and access systems 250. The coolers 110 may be side by side, stacked, or positioned in any other configuration. One cooler 110 may have more than one door 120 or access point.

In use, the cooler 110 may be stocked with a number of the products 10. The products 10 preferably, but not necessary, each have the same weight (at least within each compartment). Having multiple coolers 110 and/or multiple doors 120 may provide a vending system 100 with the ability to sell products 10 of different prices and/or different types of products 10. Multiple weighing systems 300 may be used for each type of product 10 or the controller 220 may attribute each weight differential to a specific type of product 10.

The weighing system 300 then determines the weight of the cooler 110. Based upon the weight, the controller 220 of the user interface 150 or otherwise, thus determines the number of products 10 currently positioned within the cooler 110. The display 230 of the user interface 150 may provide a message such as “Insert Your Key To Enjoy Your Drink And Hydrate Yourself” or any desired message. The required number of credits or cost also may be displayed. Any type of messaging may be used.

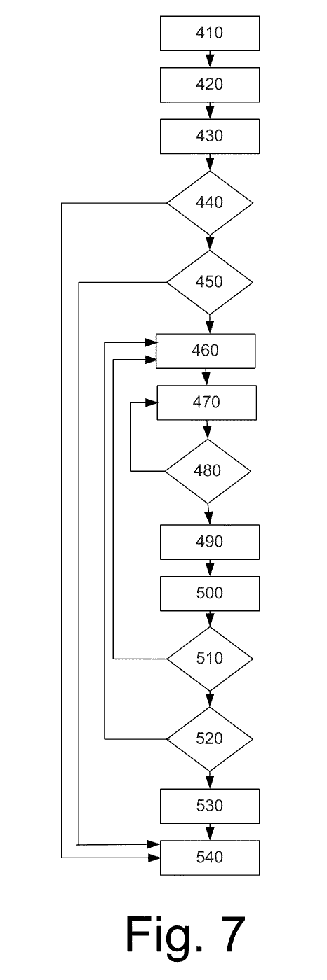

FIG. 7 is a flow chart showing the steps in one example of a vending transaction 400. The vending transaction 400 may begin at step 410 wherein the key 185 is inserted within the key hole 190 of the user interface 150. The key 185 may be locked into place via the key retaining solenoid at step 420 and then read by the RFID reader 170 at step 430. At step 440, the electronic payment system 160, in communication with the RFID reader 170 and the controller 220 or otherwise, may determine whether the RFID card 180 is authorized. At step 450, the electronic payment system 160 determines if the RFID card 180 has enough credit thereon. If the RFID card 180 is not authorized or if the RFID card 180 does not have sufficient credit, the key 185 may be released. The display 230 may instruct the user to charge the RFID card 180 with additional cash or credits.

If the RFID card 180 does have sufficient credit thereon, the door 120 may be unlocked via the access system 250 at step 460. The user then may remove one or more products 10 from the cooler 110 at step 470. At step 480, the proximity sensor 340 determines that the door 120 is closed and, if so, the access system 250 thus locks the door 120 at step 490.

At step 500, the weighing system 300 weighs the cooler 110. At step 510, the weighing system 300 determines if the weight is less than, equal to, or more than the previous weight. If the weight is more, the door 120 of the cooler 110 may be again unlocked as in step 460. The user likewise may be instructed to remove the additional weight such as an unauthorized product the user intended to chill. If the weight is less, the weighing system 300 determines whether the difference is a multiple of the product weight at step 520. If so, the monetary value or the credits for the number of products 10 removed is subtracted and a revised credit balance is written on the RFID card 180 via the RFID reader 170 at step 530. If the weight is equal, then no subtractions or revisions are made. The key 185 then may be released at step 540 and the transaction 400 is completed.

Although other protocols may be used herein, the RFID card 180 preferably has enough credit thereon to purchase at least one product 10 therein before the door 120 is opened. If more than the credit for one product 10 is required, a negative balance may be applied to the RFID card 180. The display 230 may remind the user to add credits or cash to the RFID card 180. Credit generally must be added and a positive balance must exist before the vending system 100 will vend another product 10.

Restocking the cooler 110 may be initiated by the use of a master RFID key 185. The master RFID key 185 may alert the vending system 100 that products 10 are to be added to the cooler 110. The electronic payment system 160 may write the number of products 10 inserted into the cooler 110 onto the master RFID key 180 or otherwise account for the additional products 10. Similarly, a self-service RFID key 185 also may be used. With a self-service key 185 and the like, users may stock the vending system 100 themselves as opposed to the traditional vending route supplier. Such a key 185 may be used only for a limited number of times so as to limit the chances of misuse and the like.

The vending system 100 thus may use an existing cooler 110 and provide controlled access thereto via the user interface 150 and the access system 250 while providing easy payment via the electronic payment system 160 and the weighing system 300. The vending system 100 thus is appropriate for use in either lower volume locations or locations where the aesthetics or noise of a traditional vending machine may not be appropriate. Specifically, the vending system 100 may be appropriate for small or medium sized enterprises where somewhat lower sales may be expected. The vending system 100 thus may have a relatively small size with associated lower noise levels so as to be appropriate in environments such as offices and the like.

Moreover, use of the vending system 100 or multiple systems 100 may greatly increase the number of vending opportunities even for larger enterprises. In other words, the density of vending opportunities and the number of points of interruption may be increased through the use of multiple vending systems 100. The closer a user is to the vending system 100, the greater chance of use.

It should be apparent that the foregoing relates only to the preferred embodiments of the present application and that numerous changes and modifications may be made herein by one of ordinary skill in the art without departing from the general spirit and scope of the invention as defined by the following claims and the equivalents thereof.

We claim:

1. A vending system for dispensing a number of products, comprising:
an enclosure with an access point;
a weighing system;
a user interface;
wherein the user interface comprises a proximity card coupling device to read and write to a proximity card; and
an access system;
wherein the access system allows the access point of the enclosure to be accessed in response to the user interface so as to permit a user to access one or more of the number of products.

2. The vending system of claim 1, wherein the enclosure comprises a glass door cooler.

3. The vending system of claim 1, wherein each of the number of products comprises a substantially identical weight.

4. The vending system of claim 1, wherein the user interface comprises a user interface module.

5. The vending system of claim 1, wherein the proximity card comprises a key and wherein the user interface comprises a key hole for mating therewith.

6. The vending system of claim 1, wherein the user interface comprises a key retaining solenoid.

7. The vending system of claim 1, wherein the user interface comprises a display.

8. The vending system of claim 1, wherein the access system comprises a bar positioned by the access point.

9. The vending system of claim 8, wherein the bar is operated by a solenoid.

10. The vending system of claim 1, wherein the weighing system comprises a plurality of weight transducers.

11. The vending system of claim 1, wherein the weighing system comprises a proximity sensor positioned about the access point.

12. The vending system of claim 1, wherein the weighing system comprises a weighing module.

13. The vending system of claim 1, wherein the user interface comprises a controller.

14. A method of vending a number of products from an enclosure:
reading a proximity card in a user interface;
determining if the proximity card has a sufficient amount of credit thereon;
allowing an access point of the enclosure to be opened if the proximity card has the sufficient amount of credit therein;
weighing the enclosure;
determining the number of products removed from the enclosure based upon the weight of the enclosure;
determining the value of the number of products removed; and
writing a revised credit balance onto the proximity card at the user interface.

15. The method of claim 14, further comprising accepting the proximity card in the user interface.

16. The method of claim 14, further comprising locking the proximity card within the user interface.

17. The method of claim 14, further comprising displaying a message on the user interface if the proximity card does not have a sufficient amount of credit thereon.

18. The method of claim 14, further comprising determining when the access point of the enclosure is shut.

19. The method of claim 18, further comprising locking the access point of the enclosure once the access point is shut.

20. A vending system for dispensing a number of products, comprising:
a cooler with a glass door;
a weighing module positioned under the cooler;
a user interface module positioned about the cooler and in communication with the weighing module;
wherein the user interface comprises a proximity card coupling device to read and write to a proximity card; and
an access system positioned about the door of the cooler;
wherein the access system allows the door of the cooler to be opened in response to the user interface determining that the proximity card has a sufficient amount of credit thereon.
